(19) United States
(12) Patent Application Publication
(10) Pub. No.: US 2009/0188506 A1
(43) Pub. Date: Jul. 30, 2009

(54) INTEGRAL VALVE EFFECT RESPIRATOR

(76) Inventors: John Duke, Providence, RI (US); Ritu Goel, Lincoln, RI (US)

Correspondence Address: MCDERMOTT WILL & EMERY LLP, 28 STATE STREET, BOSTON, MA, 02109-1775, US

(21) Appl. No.: 12/359,414

(22) Filed: Jan. 26, 2009

Related U.S. Application Data
(60) Provisional application No. 61/023,246, filed on Jan. 24, 2008.

(51) Int. Cl. A62B 18/02

(52) U.S. Cl. 128/206.19

(57) ABSTRACT

A respirator comprises: a nose and mouth covering porous filter body and a flexible restraining device arranged so that the body may pivot in a transverse plane about its nose contact portion, and the restraining device attaches to the body at positions where its restraining force imparts torque in the body about said nose contact portion so that the chin contact portion of said body bears against the user's chin.

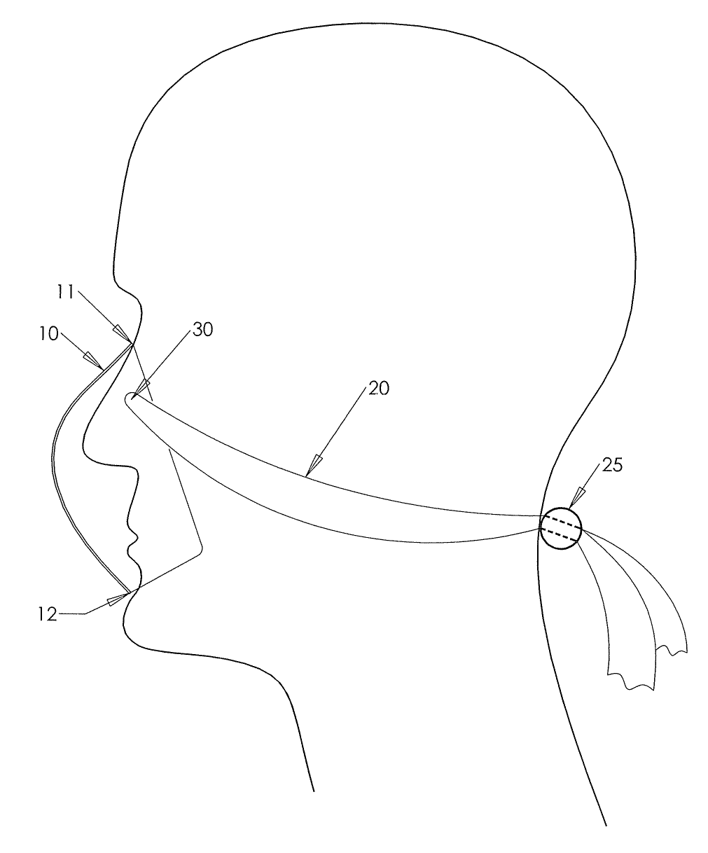

### RELATED APPLICATION

This application is based upon and claims priority from U.S. Provisional Application Ser. No. 61/023,246 filed Jan. 24, 2008.

### FIELD

The disclosure relates to respirators, and more particularly to a integral valve effect respirator.

### BACKGROUND OF THE DISCLOSURE

For individuals that are sensitive to airborne allergens, the severity of an allergic response is often not linearly proportional to the concentration of allergens in the air they breathe. Often there is little or no response unless exposure exceeds the particular threshold concentration that triggers a cascading symptomatic reaction. To prevent onset of such symptoms, it is therefore only necessary to limit exposure to some concentration below that threshold. Presently available personal respirators vary in both filtration efficiency and degree of user comfort, and these qualities are generally inversely proportional to each other.

Presently available personal respirators also commonly incorporate a one-way valve feature that allows free expiration, to reduce required breathing effort and to minimize inspiration of previously expired carbon dioxide. Such valve features add weight, bulk, and cost.

### SUMMARY OF THE DISCLOSURE

Therefore, a first objective is to provide a personal respirator that maximizes user comfort while providing filtration efficiency sufficient only to maintain allergen exposure below an allergic reaction threshold. A second objective is to provide a personal respirator whose entire body can efficiently function as a respirator valve, so that during expiration air can pass between the periphery of the mask and the user's face. For users of a personal respirator a particular cause of discomfort is tension created by its holding strap and the resultant pressure of the mask edge on the user's face. An additional objective is to minimize these particular discomforts.

This respirator is an adjunct for the management of allergies that can complement oral medications and immunotherapy. It provides an alternative to avoidance. It will serve a great need for people with allergies and/or asthma, people living in environments with heavy pollution, and those who frequently travel by commercial aircraft. It is a device that is beneficial to a user's overall health.

In an embodiment the respirator comprises a nose and mouth covering porous filter body and a flexible restraining device arranged so that the body may pivot in a transverse plane about its nose contact portion, and the restraining device attaches to the body at positions where its restraining force imparts torque in the body about said nose contact portion so that the chin contact portion of said body bears against the user's chin. The attachment points where the restraining device attaches to said body can be substantially within the transverse plane containing both the nose contact portion and the chin contact portion. The restraining device can be non-elastic. The restraining force of the restraining device can result from its catenary deflection by gravity. The restraining device can be user adjustable. The respirator can comprise hydrophilic material so that it both captures user expiration moisture and humidifies user inspiration air.

### GENERAL DESCRIPTION OF THE DRAWING

The drawing shows one embodiment of the respirator worn by a user.

### DETAILED DESCRIPTION OF THE DRAWING

Referring to the drawing, a filter mask body 10 is constructed of some material sufficiently porous to allow air to be drawn through the mask when inhaling, but prevent flow-through of known allergens of predetermined sizes. Mask body 10 incorporates an upper nose contact portion 11 in its transverse plane and a lower chin contact portion 12 in its transverse plane. A non-elastic holding strap 20 incorporates a rearward length adjusting means 25, a left mask connection means 30, and a right mask connection means 31 not shown. In the transverse plane of mask 10, a distance A extends from nose contact portion 11 to a point between connection means 30 and 31, and a distance B extends from chin contact portion 12 to a point between connection means 30 and 31.

In operation, the user places mask body 10 so that nose contact portion 11 bears on his or her nose and chin contact portion 12 is adjacent to his or her chin. The user adjusts the length of strap 20 so that it drapes in a catenary form between the back of his or her neck and connection means 31 and 32. The weight of strap 10 in this catenary form provides a low magnitude strap tension on connection points 30 and 31. When strap 20 is so adjusted the resultant force of mask body 10 on the user's face is sufficiently low to avoid discomfort and yet positions the mask so that when the user inhales, air flows through the porous mask, and when the user exhales a portion of the air flows around the edges of the mask, as described more fully below. In the above arrangement a chin bearing force between chin contact portion 12 and the user's chin results from a force couple in mask body 10 substantially equal to such strap tension force times distance A. The ratio of such chin bearing force to such strap tension force is substantially proportional to the ratio between distances A and B. In the preferred embodiment, the magnitude of such chin bearing force is less than user expiration force on the pores of mask body 10, so that chin contact portion 11 separates from the user's chin during expiration. This separation allows user breath to escape around the periphery of mask body 10 during expiration. During inspiration the above chin bearing force combines with resistance of air passage though the pores of mask body 10 to seal chin contact portion 12 against the user's chin. Mask body 10 thereby provides an integral a one-way valve means.

Alternatively, mask body 10 may be fabricated from a hydrophilic material so that it absorbs moisture from the portion of user expiration breath that passes through it. During inspiration a portion of this moisture is then recycled to humidify user air intake.

Because certain changes can be made to the above described apparatus and methods without departing from the scope of the invention, it is intended that all matter contained in the above description or shown in the accompanying drawings shall be interpreted as illustrative and not in a limiting sense.

We claim:

1. A respirator comprising:
a nose and mouth covering porous filter body and a flexible restraining device arranged so that:
the body may pivot in a transverse plane about its nose contact portion, and
the restraining device attaches to the body at positions where its restraining force imparts torque in the body about said nose contact portion so that the chin contact portion of said body bears against the user's chin.

2. The respirator of claim 1, wherein the attachment points where the restraining device attaches to said body are substantially within the transverse plane containing both the nose contact portion and the chin contact portion.

3. The respirator of claim 1, wherein the restraining device is non-elastic.

4. The respirator of claim 3, wherein the restraining force of the restraining device results from its catenary deflection by gravity.

5. The respirator of claim 1, wherein the restraining device is user adjustable.

6. The respirator of claim 1, wherein the body includes hydrophilic material, and the hydrophilic material of said body both captures user expiration moisture and humidifies user inspiration air.
